(19) United States
(12) Patent Application Publication
(10) Pub. No.: US 2005/0242673 A1
(43) Pub. Date: Nov. 3, 2005

(54) Earth's magnetic lines of force motor/generator

(76) Inventor: William E. Lyons, Halfmoon, NY (US)

Correspondence Address: W. E. Lyons, 5 Schuyler Court, Clifton Park, NY, 12065, US

(21) Appl. No.: 10/834,956

(22) Filed: Apr. 30, 2004

(51) Int. Cl. H02K 47/04; H02K 47/14; H02K 47/20

(52) U.S. Cl. 310/113

(57) ABSTRACT

A continuously rotating North seeking electro-magnet which attempts to align itself with the Earth's magnetic lines of force. The electro-magnet has the ability to change its polarity with each one-half revolution in the case of a unit with one electro-magnet only. With each half revolution the rotation is accelerated due to a boost given by the collapsing magnetic field in the electro-magnet at the moment of polarity reversal. The device is not self starting, starting from a external source of power, such as a battery. The device is connected to a generator which only requires that it be caused to rotate to develop electrical current. The output from this generator is then used to energize the electromagnet described in the first paragraph. The outside source of starting power may then be disconnected once the motor/generator is up to speed. The device is then running without a external source of power and will run continuously while generating electricity.

### FIELD OF INVENTION

This invention relates to the creation of electrical power using the earth's magnetic lines of force as the means, in conjunction with the rotating machinery and electrical apparatus herein described.

### BACKGROUND OF INVENTION

Having searched the U.S. Patent Office files via the website, it has been determined that the problem of producing electrical power is a subject that has evoked much effort on the part of many inventors. In particular I am referring to U.S. Class 310/40 MM.

### PRIOR ART

On thorough study of these files it has been determined that the invention described herein appears to be an entirely new approach to the problem and is therefore unique.

### SUMMARY OF INVENTION

The basic principle starts with the simple magnetic compass. The magnetic needle rotates until it aligns itself with the earth's magnetic lines of force, then stops.

What if, somehow, the magnetic needle, at the moment it would have stopped suddenly reversed its magnetism? It would continue to rotate.

The invention described in detail herein fully explains how this continuous rotation is accomplished and how in turn it is connected to a device to create electrical power.

To begin with the magnetic needle is replaced by a magnetic coil, which has many turns of wire wrapped around an iron core. This magnetic coil (Armature is temporarily energized by a source of direct electrical current (Battery). Connection is made to the armature through a stationary commutator and contactors (Brushes). At each half revolution of the armature the magnetic poles of the armature reverse polarity and the armature continues to rotate. It must be noted at the instant of reversal, there is a collapsing magnetic field which is very powerful in reversing the direction of flow of current in the coils. In effect, it gives a boost in the direction of rotation. The slow moving rotation of the armature from the initial start, accelerates in speed with each revolution, much like a falling body, each second increases in velocity. At this point, the device is still connected to the battery.

When the device is up to speed and by means of a common drive shaft, it is now causing electric current to be produced in a generator. This electric current, by means of a rotating commutator and through a switch is fed back to the stationary commutator, the brushes and then the armature. The switch connecting the battery can now be opened to run without the battery or it may remain closed to recharge the battery.

However it is decided to run, the machine is now producing electric power to keep itself going and to provide additional power for other purposes, all from the earth's magnetic lines of force and the means herein described.

It can be appreciated that this source of electrical power is helpful to mankind in many ways. The magnetic lines of force are not consumed, therefore the source is not being depleted. There are no emissions to pollute the earth's atmosphere. The magnetic lines of force are generally available all over the earth where mankind exists. No one country would have a monopoly.

The invention as described is a working model without scale. The machine may be as big as a furnace in a home, a self contained source of electrical power, independent of external utilities. It could also be a huge piece of machinery, weighting tons and rotating on air bearings, distributing its power to a large manufacturing facility or a municipality. The invention as described is just a beginning. Those skilled in the art may readily amplify on this principle as a natural progression of thought and experimentation. I would expect no less and I welcome all.

### DESCRIPTION OF THE DRAWINGS

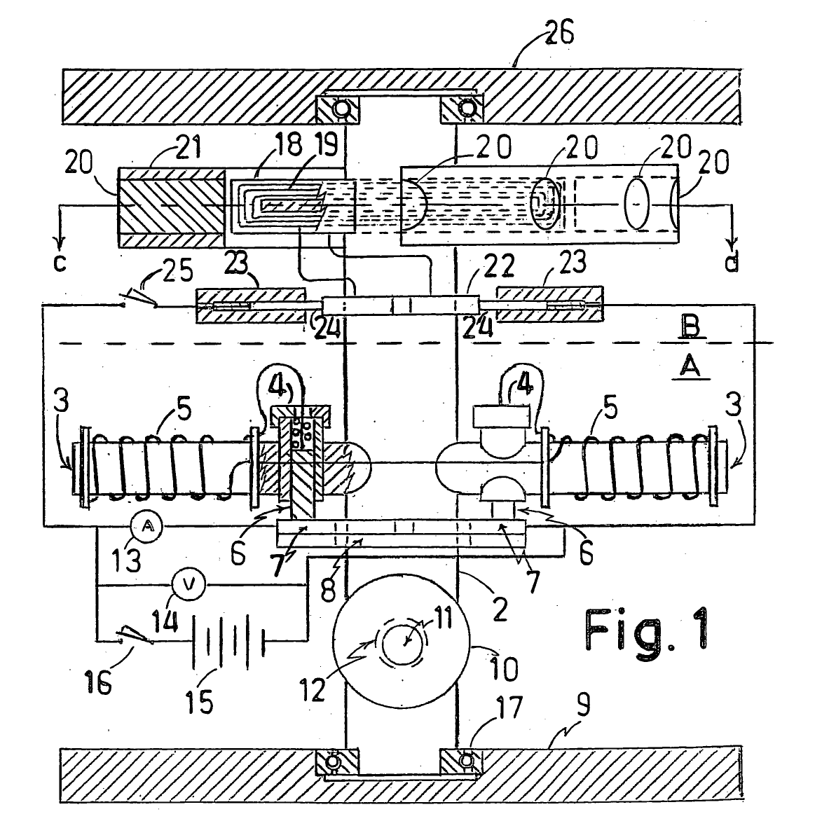

To better understand the invention, sheet 1 of 2 shows the complete device and is designated FIG. 1. FIG. 1 is divided by a dash line, and labeled A below the dash line. This is the motor section of the device. Above the dash line it is labeled B. This is the generator section of the device.

The motor A and the generator B are on a common drive shaft 2 which is of non magnetic material. The armature 3 is one continuous iron bar mounted directly through the shaft 2. There are two brush holders 4, one on either side of the shaft 2. These are mounted directly through the armature 3. There are two spools of wire 5 mounted on the armature 3. These spools are both wrapped in the same direction and connected to one another. The beginning and end wires of these joined coils terminate at, insulated, spring loaded brushes 6. The brushes 6 are in contact with an non-rotating commutator 7. This commutator is made of two segments of a conducting metal. The hole in the commutator is much larger than the diameter of the shaft 2. This assures that there is no electrical connection to the shaft and that the shaft is free to rotate. The commutator 7, does not rotate and is mounted on an insulator 8 which in turn is mounted to the base plate 9. A counterweight 10 is mounted on a threaded bar 11 which runs directly through the shaft 2 and has a second counterweight on the far end of this bar. The purpose of these counterweights 10, which are adjustable by means of the thread 12, is to offset the imbalance caused by the weight of the rotating armature 3 and to reduce vibration.

The other items shown in the motor section are.
13 Ammeter
14 Voltmeter
15 Battery
16 Single Pole Switch
17 Lower Bearing
28 Output Terminals

Visualize this device as an electric motor with an outer shell and end bells. In the drawing there is no attempt to show an outer shell connecting the end plates 9 and 26 (End bells). Also, the device operates with the end plate 9 being the base and the rotating shaft 2 being vertical.

Section B of FIG. 1 is the generator section of this device. This generator provides the necessary current for the armature 3 of the drive motor in section A when the battery 15 is not in use.

The generator armature 18 is mounted through the common drive shaft 2 and rotates synchronously with the armature 3 of the drive motor in section A Unlike most generators the armature does not contain magnetic materials, such as iron. The armature frame 18 is of non magnetic material, upon which many turns of wire 19 are wrapped. The end turns of these wires are wrapped vertically so that they cut through and sever the lines of force of the permanent magnets 20 as the armature rotates. In doing so they induce a current to flow in the wires 19 since they are part of a closed circuit, when switch 25 is closed.

The wire endings from the armature are attached to a rotating commutator 22 which is fixed too but electrically insulated from the drive shaft 2.

Two brush holders 23, which are non-rotating and affixed to the frame of the machine contain spring loaded brushes 24 which contact the segments of the commutator 22 and allow the current to flow thru switch 25 thru the ammeter 13 and too one segment of the non-rotating commutator 7 of the driving motor in FIG. 1 section A., thru one spring loaded brush 6 thru the coils 5 and 5 then down thru the brush holder 4 and the second spring loaded brush 6 to the other segment of the stationary commutator 7 then to the spring loaded brush 24, in the generator section B and to a segment of the rotating commutator 22 which is attached to the other end of the coil 19 in the armature 18, completing the circuit.

This generator provides the necessary current for the armature of the drive motor in section A FIG. 1 when the battery is not in the circuit and for additional current for other purposes at terminals 28 and 28.

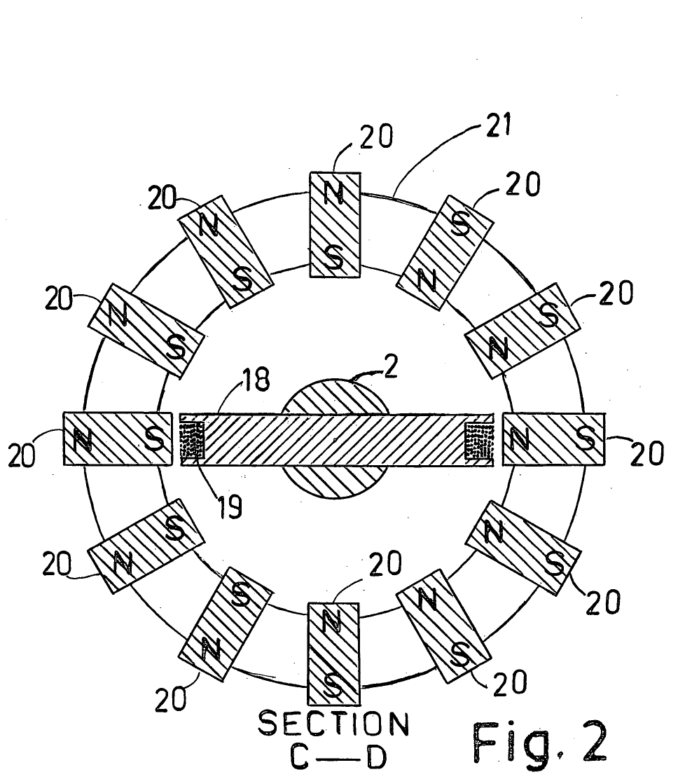

To better understand the generator, a cross-section is indicated in FIG. 1 as c-d. This cross-section c-d shows the generator from the top at the section line c-d in a drawing shown as FIG. 2. In FIG. 2 you can see that the permanent magnets 20 are mounted in a ring 21 with half of the magnets being North facing and the other half being South facing. The ring 21 holds these magnets accurately in place. The ring 21 and the magnets 20 do not rotate.

The sectioned armature 18 is shown going directly through the drive shaft 2. The wires 19 are shown standing vertical at the both ends of the armature 18.

This generator differs from the conventional type where the armature is a slotted cylinder with coils being wound in the slots and each coil having two commutator segments per coil.

The fact that I choose to use a different type generator than the conventional slotted armature type does not excluded the conventional generator from use; however, this generator has advantages which are more suited to the application and will be so noted in the claims.

Having described the embodiment of a Motor/Generator using the Earth's Magnetic Lines of Force according to the invention, other modifications and variations of the invention will be suggested to those skilled in the art in the light of the above teachings. It is therefore to be understood that changes may be made in the particular embodiments of the invention described which are within the full intended scope of the invention as defined by the appended claims.

1. A continuously rotating motor/generator using the Earth's Magnetic lines of force.

2. A continuously rotating motor/generator having a long member or members whose ends can be changed from North magnetic to South magnetic and visa versa.

3. A continuously rotating motor/generator having a long member or members of high magnetic permeability and low magnetic retentivity.

4. A continuously rotating motor/generator having a long member of high magnetic permeability wrapped with a coil of wire, or many layers of wire, through which electric current may flow.

5. A continuously rotating motor/generator having a long member or members wrapped with wire whose ends are connected to contactors and a source of direct current power for the purpose of starting rotation.

6. A continuously rotating motor directly connected to a generator which, by switching means, feeds current back into the coils of the rotating member of the motor at the same time disconnecting the source of direct current used for starting.

7. A continuously rotating motor directly connected to a generator which may remain connected to the source of starting power if the source is a battery and it is desired to continuously keep the battery charged.

8. A continuously rotating motor directly connected to a generator which has terminals to which other electrical devices may be connected for their operation.

9. A continuously rotating device directly connected to a alternating current generator whose output may be rectified for any purpose and a second set of terminals with non-rectified alternating current to operate other electrical devices.

10. A generator with a single armature coil providing one North ending at 0° and a second ending at 180° and a magnetic field with magnets of like polarity on one half of a circle and magnets of opposite polarity on the remaining one-half of the circle.

11. On a commercial machine, in order to increase efficiency there would be a multiplicity of the complete machine, described throughout, on a common driveshaft each machine having an armature displaced on a different angle, I.E. a double armature machine at (0°-180°) and (90°-270°). On a four armature machine at (0°-180°) and (45°-225°) and (90°-270°) and the fourth at (135°-315°).

12. A motor/generator with a single or multiple armatures as described herein in which the generator described provides only the necessary current to activate the motor armature or armatures. This whole device then by mechanical connection may drive a separate commercial generator for other purposes.

13. A complete, “stand alone”, electricity power source requiring no outside utility help other than the Earth's magnet lines of force.
